(19) United States
(12) Patent Application Publication
(10) Pub. No.: US 2010/0294868 A1
(43) Pub. Date: Nov. 25, 2010

(54) CHIPPER DRUM WITH INTEGRAL BLOWER

(75) Inventors: Edwin N. Galloway, Pella, IA (US); James L. O'Halloran, Pella, IA (US); Jeffrey D. Bradley, Pella, IA (US); John T. Bouwers, Pella, IA (US); Larry Schut, Pella, IA (US)

Correspondence Address: MERCHANT & GOULD PC, P.O. BOX 2903, MINNEAPOLIS, MN, 55402-0903, US

(73) Assignee: Vermeer Manufacturing Company, Pella, IA (US)

(21) Appl. No.: 12/599,619

(22) PCT Filed: May 1, 2008
(86) PCT No.: PCT/US2008/062214

§ 371 Date: Aug. 9, 2010

Related U.S. Application Data
(60) Provisional application No. 60/928,928, filed on May 10, 2007.

(51) Int. Cl. B02C 18/16; B27L 11/02

(52) U.S. Cl. 241/92; 241/282.1

(57) ABSTRACT

The chipper drum of the present disclosure is configured to maximize its cutting width while decreasing its overall size. In particular, the chipper drum of the present disclosure includes air deflectors recessed on the ends of the drum that are configured to generate the air flow necessary to blow chips out of the chipper.

This application is being filed on 1 May 2008, as a PCT International Patent application in the name of Vermeer Manufacturing Company, a U.S. national corporation, applicant for the designation of all countries except the US, and Edwin N. Galloway, James L. O'Halloran, Jeffrey D. Bradley, John T. Bouwers and Larry Schut, citizens of the U.S., applicants for the designation of the US only, and claims priority to U.S. Provisional Patent Application Ser. No. 60/928,928, filed May 10, 2007, which is herein incorporated by reference in its entirety.

### TECHNICAL FIELD

The present invention relates generally to a chipper and, more particularly, to a chipper having a chipper drum with an integral blower.

### BACKGROUND

Chippers are used to reduce branches, trees, brush, and other bulk wood products into small chips. A chipper typically includes an infeed chute, a feed system for controlling the feed rate of wood products into the chipper, a chipping mechanism, a drive system for powering the feed system and the chipping mechanism, and a discharge chute. For a description of an infeed chute see WOOD CHIPPER INFEED CHUTE, incorporated in its entirety herein by reference.

The chipping mechanism is commonly a large cutter drum that includes blades thereon. The drum is commonly driven by an engine via a belt. For a description of a belt drive system see BELT TENSIONING APPARATUS, incorporated in its entirety herein by reference. The drum is used to grind, flail, cut, or otherwise reduce the material fed into the chipper into small chips. Besides acting as the chipping mechanism, the drum is also commonly used to generate the air flow necessary to propel the cut chips out of the chipper.

In some prior art systems, paddles are attached to the ends of the drums to generate pressure needed to blow the chips out the discharge chute. FIG. 1 depicts a known chipper drum 10 within a drum housing 12. The chipper drum 10 is cylindrical in shape and includes a number of blades 14 and chip pockets 16 spaced apart on the cylindrical surface of the drum 10, and paddles 18 attached to the end surface of the drum 10. As the chipper drum 10 rotates about axis A in a counterclockwise direction B, it draws air into the inlet end 20 of the drum housing 12. The air flow between the chipper drum 10 and the housing 12 is accelerated by the paddles 18 through the outlet 22 of the chipper housing 12. This air flow blows the chips out of the chipper 10. In many prior art systems, the chips are blow out the rear of the chipper, which is undesirable as such chips are blow towards the operators who load the chippers from the rear.

FIG. 2 shows the chipper drum 10 rolled out flat into a rectangular shape. The paddles 18 in the known system extend beyond the edges of the cylindrical surface of the drum 10. The cylindrical surface or skin of the drum defines the cutting width W₁ of the drum 10. The cutter drum housing width W₃ needs to be large enough to allow space for the width W₂ of the drum, which accounts for the portion of the paddles 18 that extend beyond the width W₁ of the skin of the cutter drum 10.

Referring to FIG. 3, a schematic top view of a chipper 24 is shown. The chipper 24 includes a feed table 26 at the rear end of the chipper 24, a discharge chute 28 at the front end of the chipper 24, and a drum housing 12 therebetween. Feed rollers (not shown) are aligned with and positioned between the feed table 26 and the chipper housing 12. For a description of feed rollers see WOOD CHIPPER FEED ROLLER, incorporated in its entirety herein by reference. The engine 30 is positioned at the left side of the chipper 24, and the drive system 32 is positioned at a right side of the chipper 24. Increasing the width W₃ of the chipper drum housing 12 would result in increasing the overall width W_{O} of the chipper 24. Conversely, decreasing the width W₃ of the chipper drum housing 12 would enable the overall width W_{O} of the chipper to be decreased. Since it is desirable to minimize the overall width W_{O} of the chipper 24 and maximize the effective cutting width W₁ of the drum 10, it is desirable to minimize the difference between the width of the cutter drum housing W₃ and the width W₁ of the cutter drum surface.

### SUMMARY

The present disclosure relates to a chipper drum that includes a blower system housed within the drum. In one embodiment, air deflectors are located within recesses at the ends of the drum. The air deflectors cooperate with the drum housing to pressurize the chipper body, thereby causing chips within the body to propel out of the body through the discharge chute.

### BRIEF DESCRIPTION OF THE DRAWINGS

FIG. 1 is a perspective view of a prior art chipper drum and chipper drum housing;

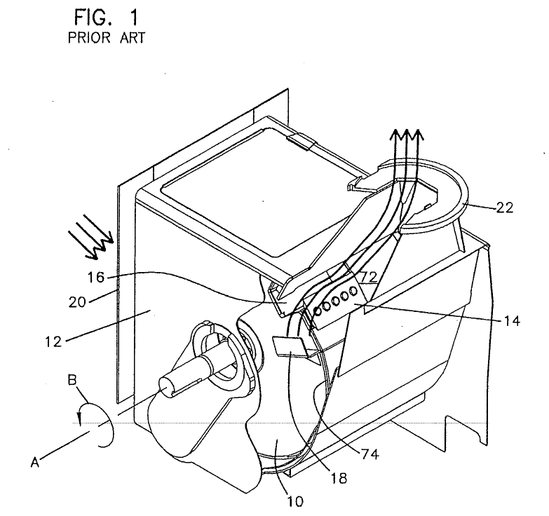

FIG. 2 is a view of the chipper drum rolled out in a flat plan view for explanatory purposes;

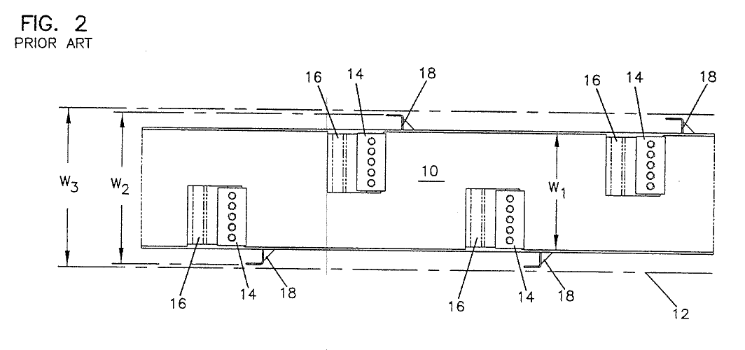

FIG. 3 is a diagrammatic view of a prior art chipper layout;

FIG. 4 is a side view of a chipper with the chipper housing and chipper drum shown in hidden lines;

FIG. 5 is a perspective view of a first embodiment of a chipper drum and chipper drum housing according to the principles of the present disclosure;

FIG. 6 is a perspective view of the chipper drum of FIG. 5;

FIG. 7 is a perspective view of the chipper drum housing of FIG. 5;

FIG. 8 is a view of a chipper drum rolled out in a flat plan view for explanatory purposes;

FIG. 9 is a diagrammatic view of a chipper layout incorporating the principles of the present disclosure;

FIG. 10 is a perspective view of a second embodiment of a chipper drum and chipper drum housing according to the principles of the present disclosure;

FIG. 11 is a perspective view of the chipper drum housing of FIG. 10;

FIG. 12 is a perspective assembly view of the chipper drum housing of FIG. 10;

FIG. 13 is a perspective view of the chipper drum of FIG. 10;

FIG. 14 is a cross-sectional view of the chipper drum and chipper drum housing generally along line 14-14 of FIG. 10;

FIG. 15 is a cross-sectional view of the chipper drum and chipper drum housing generally along line 15-15 of FIG. 10;

FIG. 16 is a cross-sectional view of a third embodiment of a chipper drum and chipper drum housing;

FIG. 17 is a cross-sectional view of a fourth embodiment of a chipper drum and chipper drum housing;

FIG. 18 is a diagrammatic view of chips moving through a chipper drum housing according to the principles of the present disclosure; and

FIG. 19 is a view of FIG. 18 with dimensions.

### DETAILED DESCRIPTION

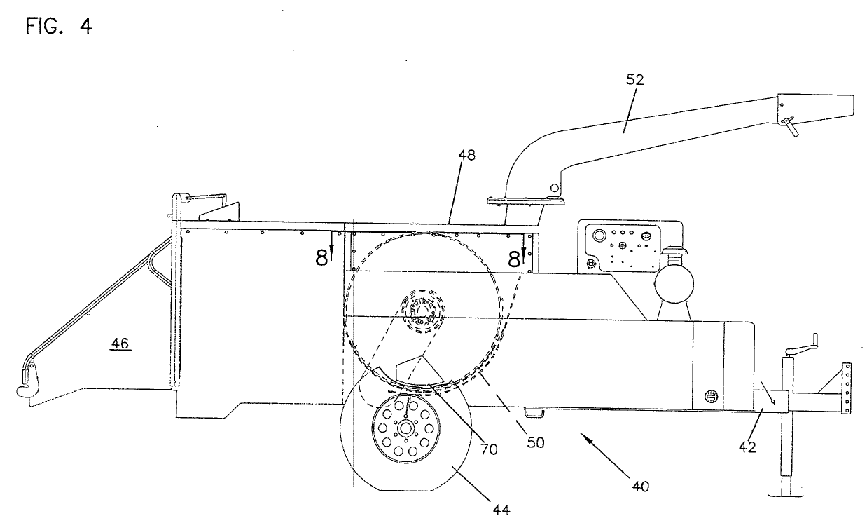

Referring to FIG. 4, a chipper 40 is shown. In the depicted embodiment the chipper 40 is mounted to a frame 42 that is supported on wheels 44, which enable the chipper 40 to be conveniently moved. The depicted chipper 40 includes an infeed chute 46, which is also commonly referred to as a feed table. The infeed chute 46 can be any structure located at the rear of the chipper 40 that facilitates the loading of materials to be chipped into the chipper 40. (The material to be chipped can be any material that the user desires to reduce to chips. The material is most commonly brush and tree parts, therefore, for convenience the material to be chipped will be referred to herein as wood, trees, or brush.) As discussed in the background, a description of an infeed chute can be found in WOOD CHIPPER INFEED CHUTE. The chipper 40 in the depicted embodiment includes an infeed system that grabs and pulls brush from the infeed chute 46 into a central body portion 48 of the chipper 40, which houses cutter-drum 50 that cuts the brush into small chips. A description of an infeed system is provided in SYSTEM FOR CONTROLLING THE POSITION OF A FEED ROLLER, which is incorporated in its entirety herein by reference. Once the cutter drum 50 reduces the materials to be chipped into chips, the chips are expelled from the chipper 40 through the discharge chute 52.

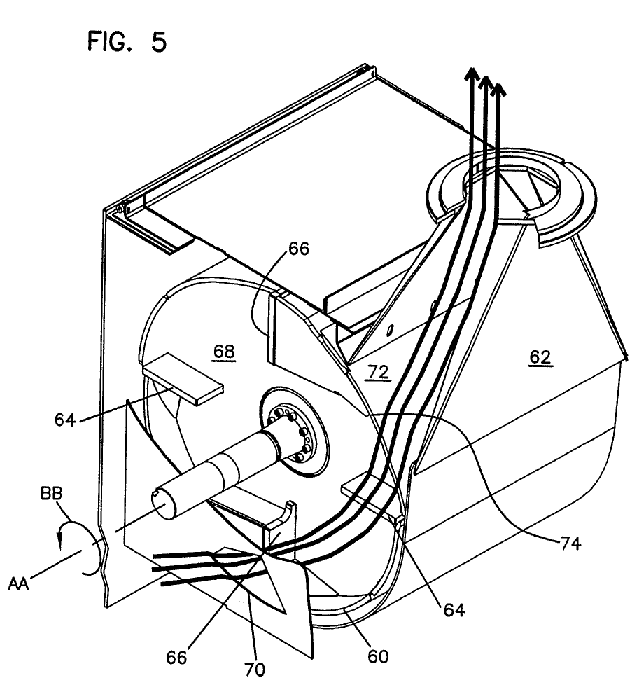

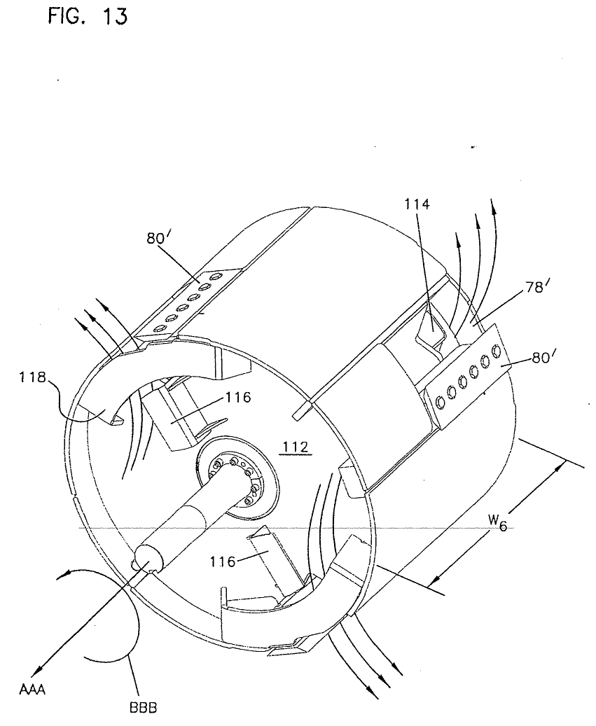

Referring to FIG. 5, a first embodiment of a cutter drum 60 and cutter drum housing 62 of a chipper 40 according to the present disclosure is shown. The cutter drum 60 includes air deflectors (e.g., paddles) 64, 66 located within end portions 68 of the cutter drum 60. In the depicted embodiment the air deflectors extend radially along recessed end surfaces of the cutter drum 60. Though the air deflectors are shown as rectangular shaped members in FIG. 5 and scooped shaped in FIG. 13, it should be appreciated that many other air deflector configurations are also possible. Since the opposed end portions 68 of cutter drum 60 in the depicted embodiment are similar, only the right side of the drum 60 shown in FIG. 5 is described in detail herein. As the drum rotates about its axis AA in the counterclockwise direction BB, air flows from the outside of the chipper drum housing 62 through aperture 70 and is accelerated by the air deflectors 64, 66 over an edge 74 of a drum skin 72 and out the discharge chute 52.

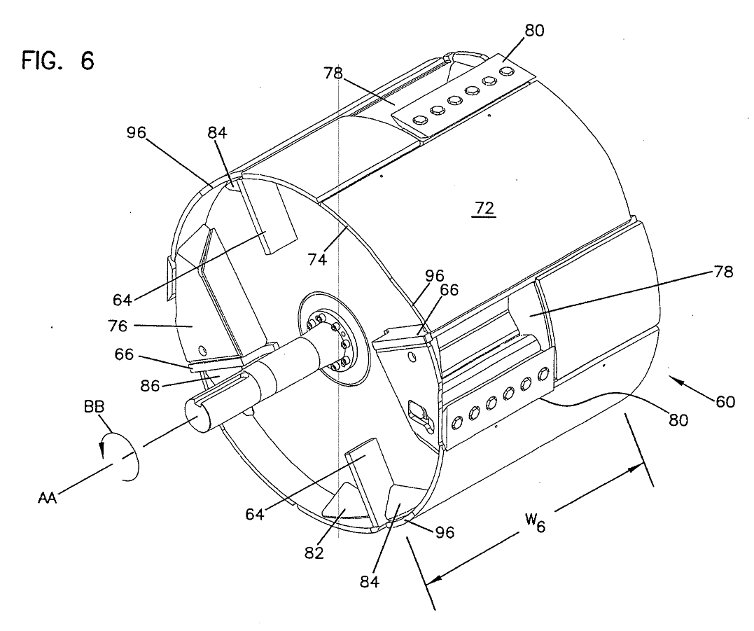

Referring to FIGS. 6-8, the cutter drum 60 and the cutter drum housing 62 are shown in greater detail. The cutter drum 60 includes auxiliary structural supports 76 on the end portion 68 of the cutter drum 60 adjacent the chip pockets 78. In the depicted embodiment, the chip pockets 78 are located directly in front of the blades 80. Also, auxiliary deflectors 82, 84, and 86 are located adjacent the deflectors 64, 66 to facilitate air flow and prevent debris buildup on the cutter drum 60. It should be appreciated that many other configurations are also possible.

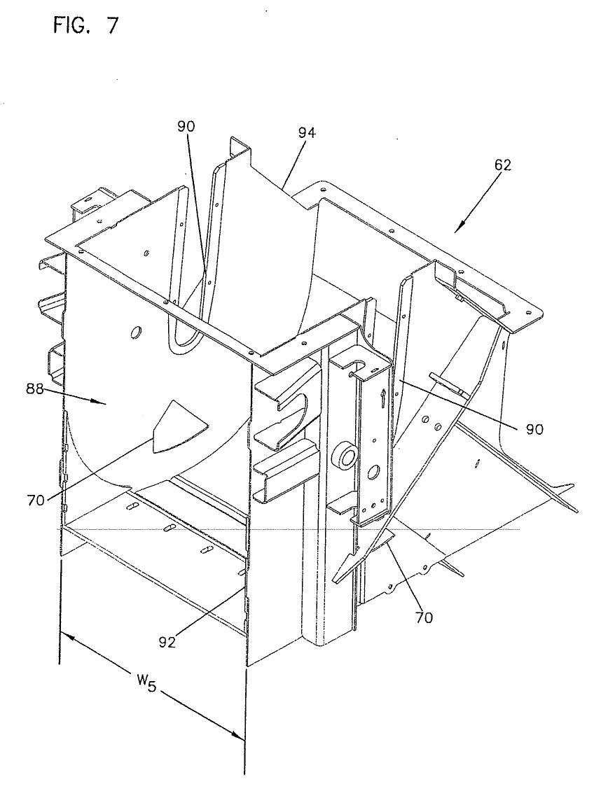

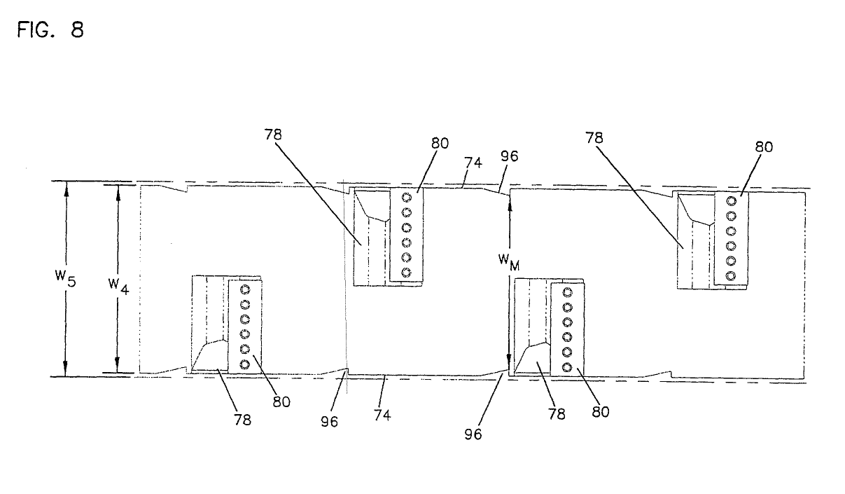

Referring to FIGS. 7-8, the cutter drum housing 62 includes a drum chamber 88, an axis support 90, an inlet 92, and an outlet 94. The cutter drum housing 62 includes a width W₅ that is slightly larger than the width W₄ of the cutter drum 60. In the depicted embodiment the width W₄ of the cutter drum 60 is also the effective cutting width of the cutter drum 60. The width W₅ of the housing is also the maximum width of the cutter drum 60. In the depicted embodiment the width W₅ is less than 6 inches greater than W₄. Preferably, W₅ is less than 1.5 inches greater than W₄. In the depicted embodiment, W₅ is approximately 28¾ inches and W₄ is approximately 28 inches. Referring specifically to FIG. 8, the cutter drum housing 62 is shown rolled out flat with air flow channels shown as notches 96. The notches 96 allow air to flow over the edges 74 of the cutter drum 60. In the depicted embodiment the width W₅ of the cutter drum 60 varies. In one embodiment the width varies by more than 1 inch and the minimum width W_{M} of the drum is located at the notches 96. Though in the depicted embodiment the notches 96 are offset from the chip pockets 78, it should be appreciated that in alternative embodiments of the drum 60 the notches 96 can be in other locations as well.

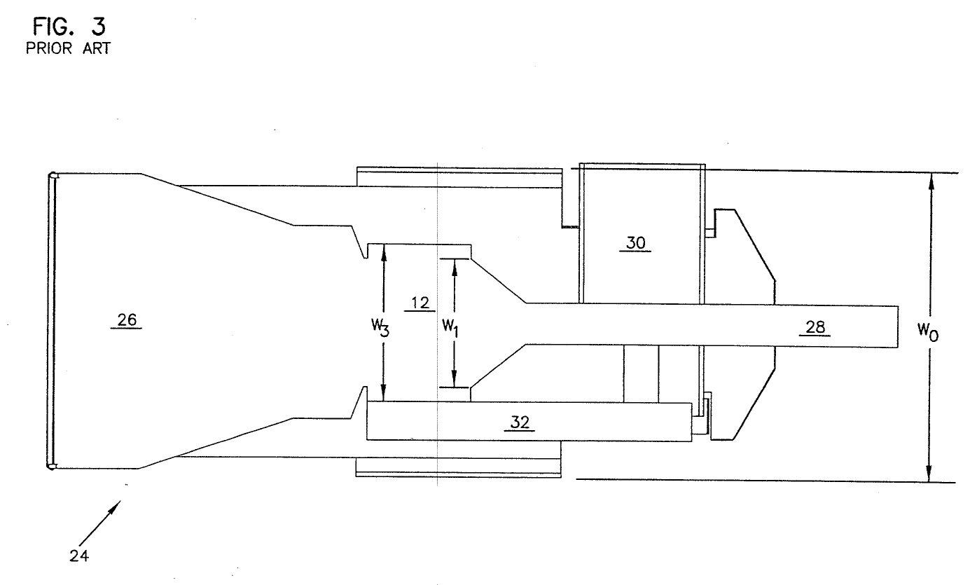

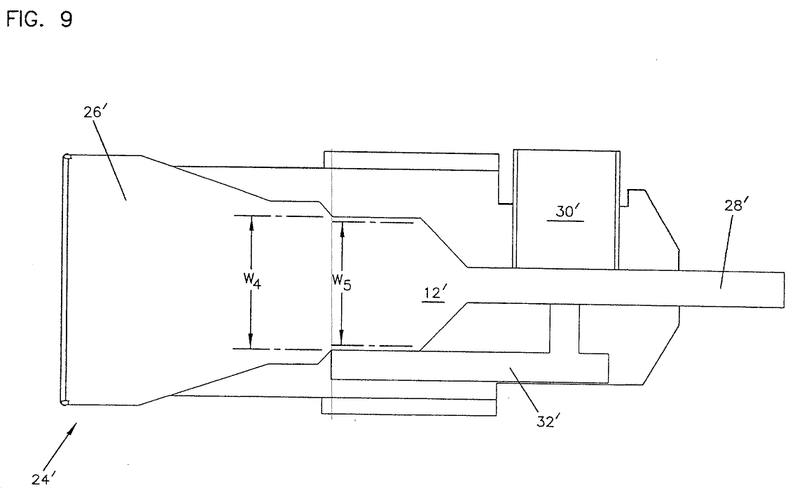

Referring to FIG. 9, a chipper layout according to the principles of the present disclosure is shown. Like FIG. 3, the chipper 24′ includes a feed table 26′ at the rear end of the chipper 24′, a discharge chute 28′ at the front end of the chipper 24′, and a drum housing 12′ therebetween. Feed rollers (not shown) are aligned with and positioned between the feed table 26′ and the chipper housing 12′. The engine 30′ is positioned at the left side of the chipper 24′, and the drive system 32′ is positioned at right side of the chipper 24′. Since the air deflectors 64, 66 of the chipper 24′ of the present disclosure are recessed relative to the edge 74 of a drum skin 72 of the cutter drum 60, the cutter drum 60 has a relatively larger cutting width than the same width cutter drums of the prior art. In the depicted embodiment the air defectors 64, 66 overlap the blades 80 of the cutter drum 60 along the width of the cutter drum 60. In the depicted embodiment, the width W₅ of the cutter drum housing 62 is closer to the width W₄ than is the width W₃ to width W₁ of FIG. 3 (prior art). The depicted embodiment increases the effective cutting width W₄ of the cutter drum 60 without increasing the width W₅ of the cutter drum housing 62. In the depicted embodiment the width W₅ is ¾ inches greater than the width W₄.

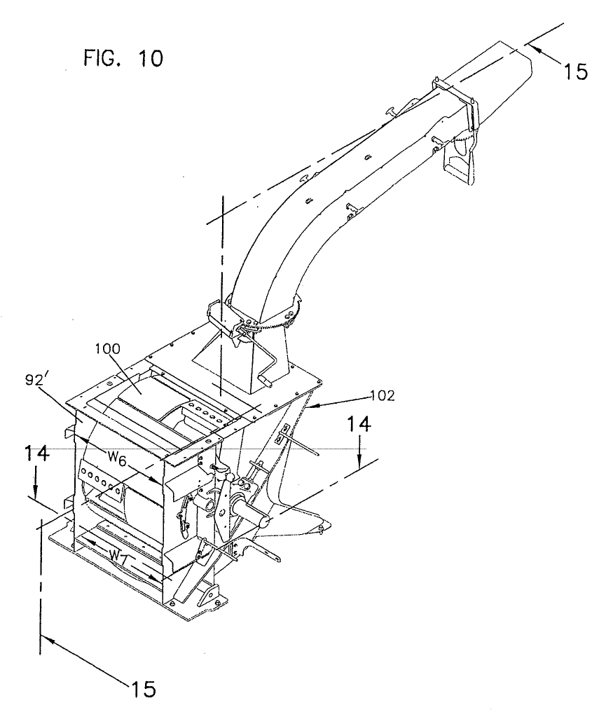

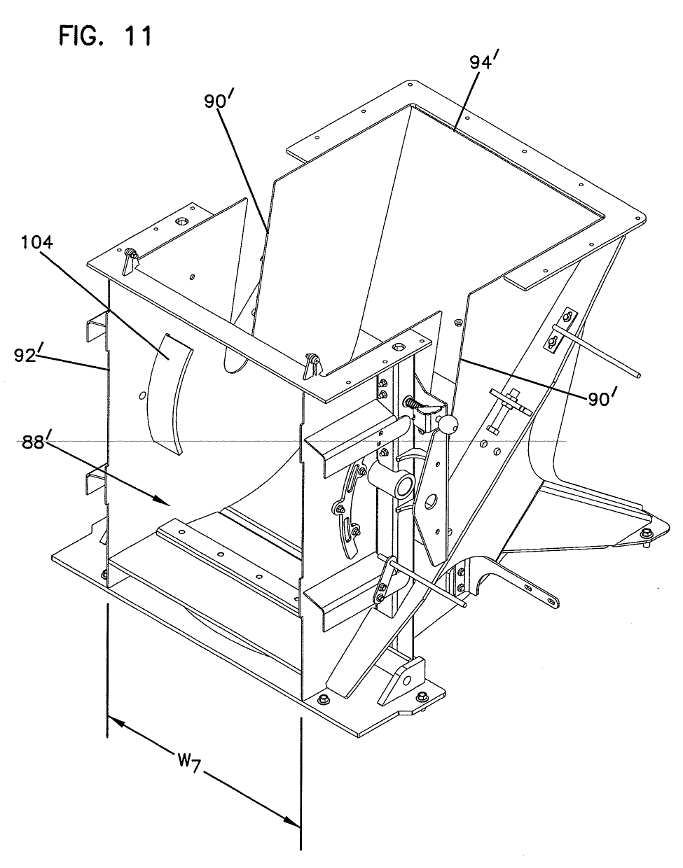

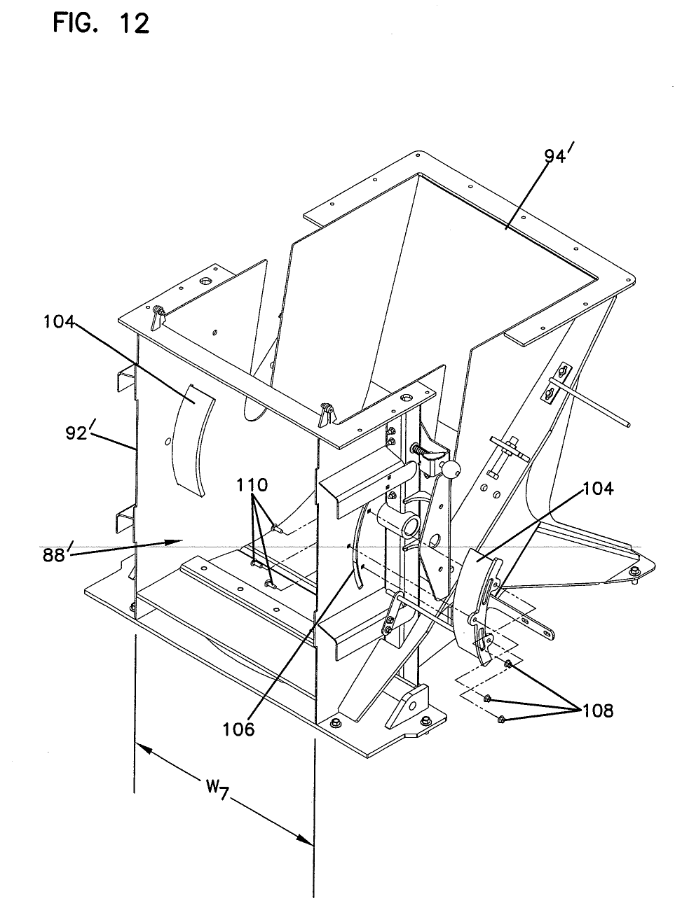

Referring to FIGS. 10-15, a second alternative embodiment of a chipper drum 100 and chipper drum housing 102 is shown. Like the first embodiment, the chipper drum 100 and chipper drum housing 102 of the second embodiment are configured such that the width W₆ of the cutting drum 100 is maximized while the width W₇ of the cutter drum housing 102 is minimized. The cutter drum housing 102 includes a drum chamber 88′, an axis support 90′, an inlet 92′, and an outlet 94′. The cutter drum housing 102 includes a width W₇ that is slightly larger than the width W₆ of the cutter drum 100. The cutter drum housing 102 also includes a housing deflector 104 for preventing air and chips from being projected out of the inlet 92′ of the cutter drum housing 102. Referring particularly to FIG. 12, the housing deflector 104 is shown in an assembly view as being mounted to the cutter drum housing 102 through a slot 106 via nuts 108 and bolts 110.

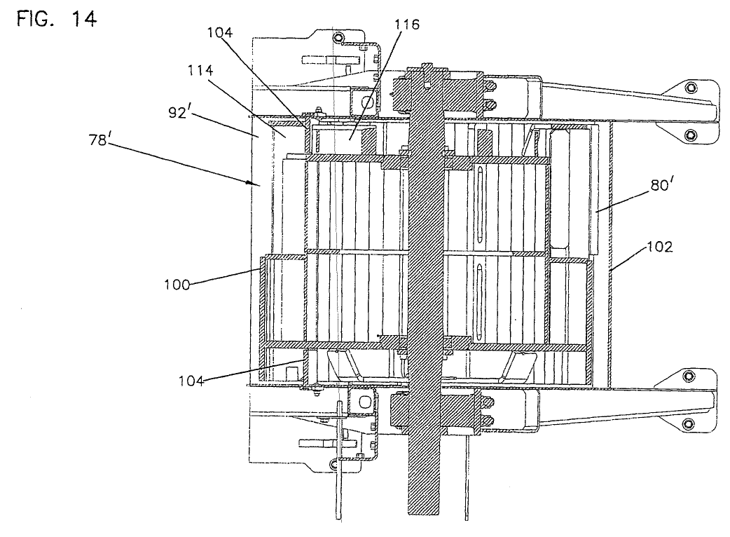

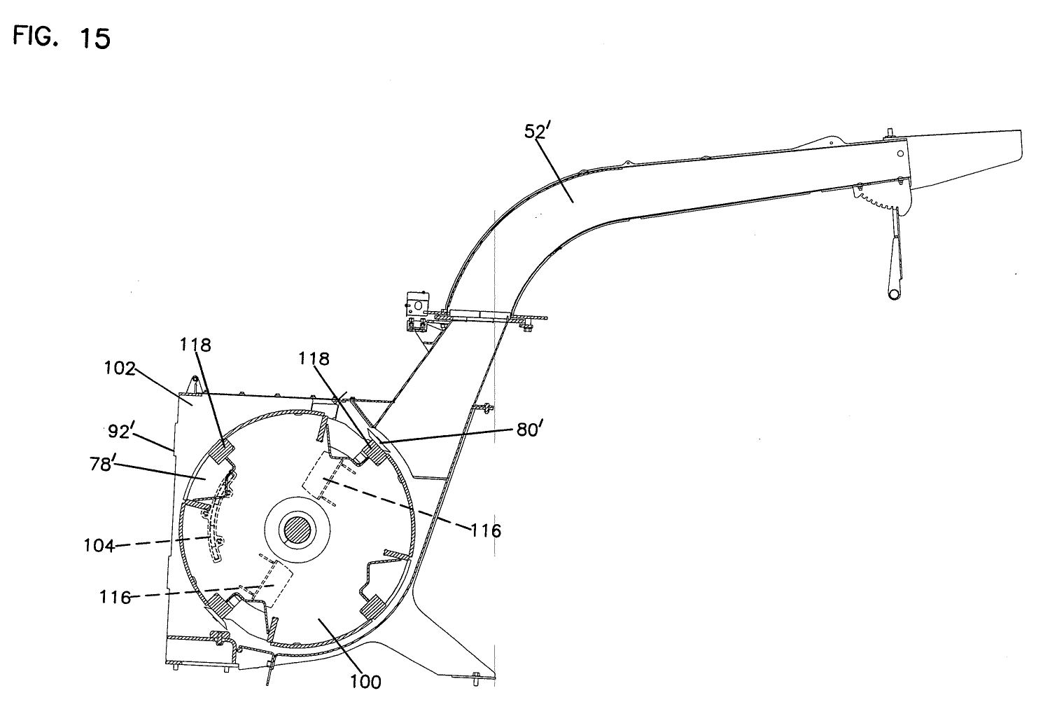

Referring to FIG. 13, the cutter drum 100 of the second embodiment does not include notches to facilitate air flow. Instead, the drum is constructed to direct air from the ends 112 of the cutter drum through a window 114 in the chip pocket 78′. In the depicted embodiment the ends are generally perpendicular to the rotational axis AAA of the drum and recessed relative to the cutting surface of the drum 100. Like the cutter drum 60 of the first embodiment, the cutter drum 100 of the second embodiment includes blades 80′ adjacent the chip pockets 78′. As the drum rotates about the axis AAA in the counterclockwise direction BBB, air from outside of the chipper drum housing 102 is accelerated by the paddles 116 and auxiliary deflectors 118 through the window 114. In the depicted embodiment the two paddles 116 are scoop shaped with an L-shaped side profile. In the depicted embodiment the L-shaped paddles 116 are directional, that is, the paddles 116 perform differently when the drum is rotated in the clockwise direction than when the drum is rotated in the counterclockwise direction. This air flow projects the chips out of the chipper. The housing deflector 104 on the housing 102 prevents air/chips from flowing through the window 114 when the pocket 78′ faces the inlet 92′ of the chipper drum housing 102, as it is desirable to blow the chips through the outlet 94′ rather than the inlet 92′. FIG. 14 is a cross-sectional view of the cutter drum 100 and cutter drum housing 102 of FIG. 10 generally along line 14-14. FIG. 15 is a cross-sectional view of the cutter drum 100 and cutter drum housing 102 of FIG. 10 generally along line 15-15. FIGS. 14 and 15 illustrate how the housing deflector 104 blocks the window 114 when the chip pocket 78′ faces the inlet 92′ of the cutter drum housing 102 to facilitate chips being ejected out of the discharge chute 52′ rather than the inlet 92′.

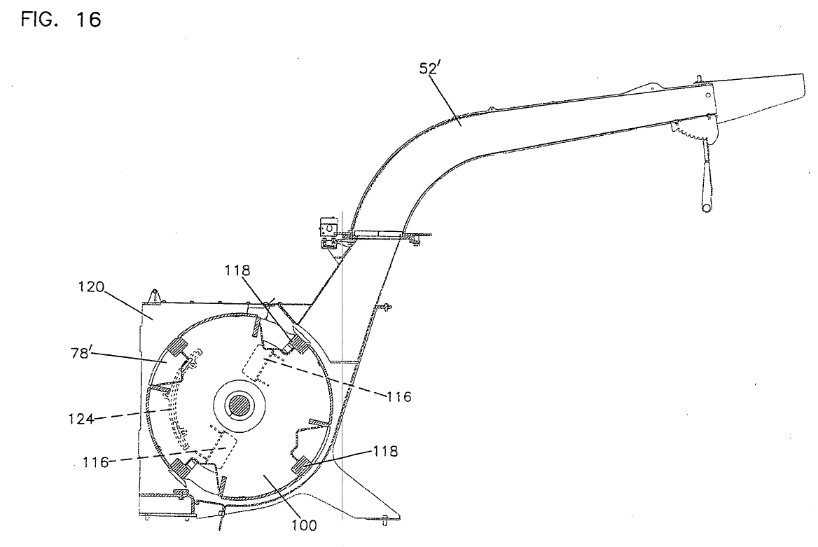

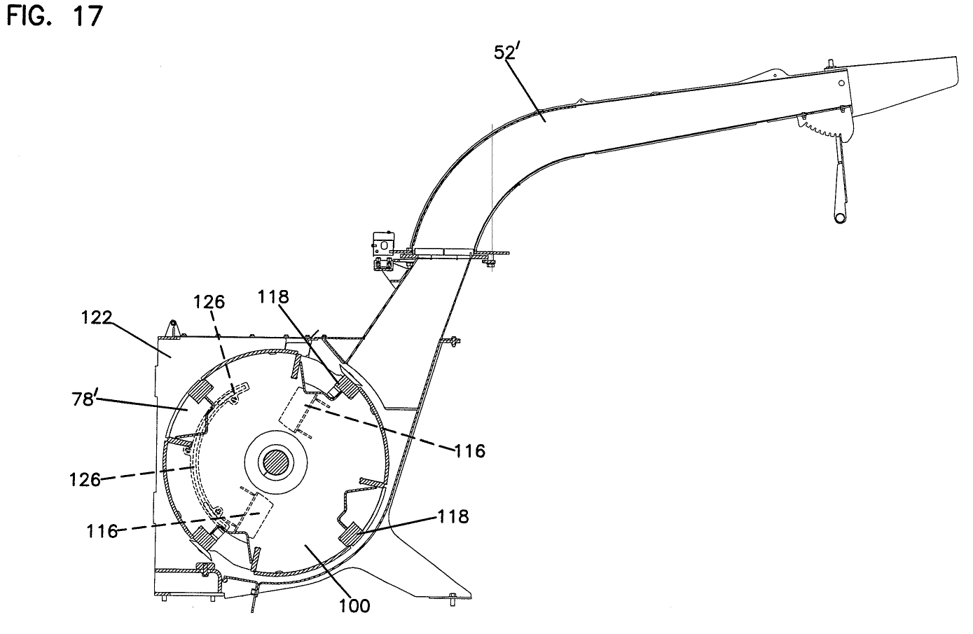

FIGS. 16 and 17 show the cutter drum 100 being housed within cutter drum housings 120, 122, which are similar to the cutter drum housing 102 of the second embodiment. The difference between the cutter drum housings 120, 122 relates to the size of the housing deflectors 124, 126.

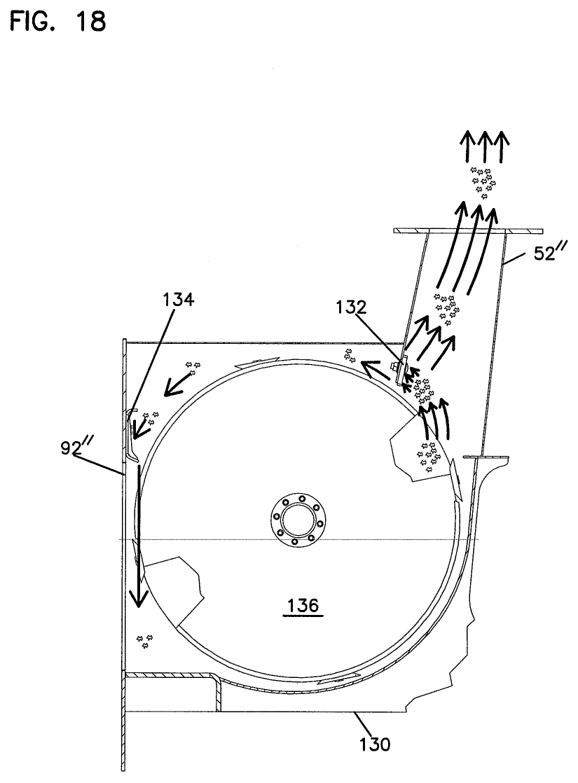

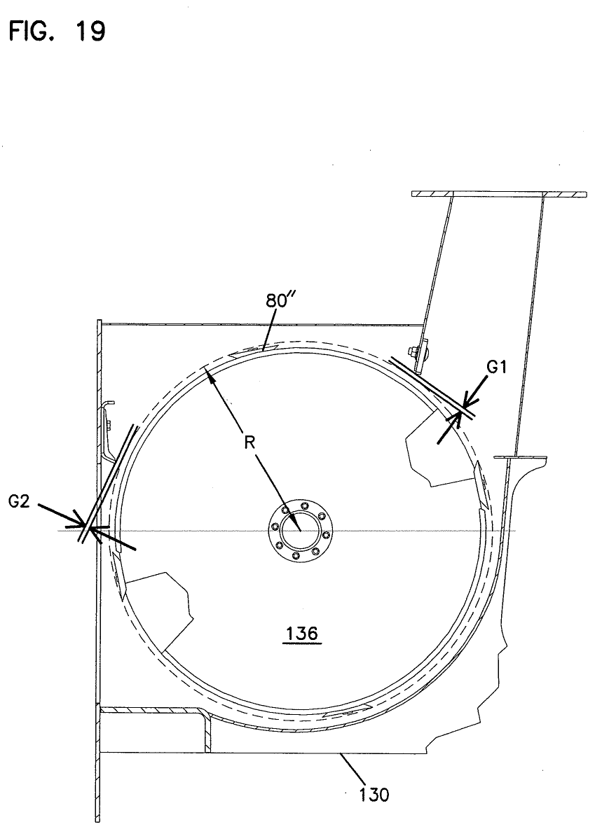

Referring to FIGS. 18 and 19, the cutter drum housing 130 includes an upper 132 and a lower 134 housing chip deflector. In the depicted embodiment, the chip defectors 132 and 134 extend substantially across the width of the drum 136. The upper and lower housing chip deflectors 132 and 134 are positioned to direct chips from the cutter drum housing 130 to the discharge chute 52″ and to further prevent chips from discharging through the inlet 92″. The upper housing chip deflector 132 primarily functions to deflect chip towards the discharge chute 52″, whereas the lower housing chip deflector 134 primarily functions to prevent chips from being ejected out of the inlet 92″ of the housing 130. In the depicted embodiments the upper and lower housing chip deflectors 132 and 134 are adjustable. In the depicted embodiment the radius R of the cutter drum 136 measured from the axis of rotation of the cutter drum 136 to the edge of the blade 80″ is between 6-25 inches. More preferably, the radius R is between 10-18 inches. In the depicted embodiment, the gap G1 between the near edge of the upper housing chip deflector 132 and the far edge of the blade 80″ in the radial direction is between 0.0315-0.25 inches. More preferably, the gap G1 is between 0.0625-0.1875 inches. In the depicted embodiment, the gap G2 between the near edge of the lower housing chip deflector 134 and the far edge of the blade 80″ in the radial direction is between 0.0315-0.25 inches. More preferably, the gap G2 is between 0.0625-0.1875 inches. Since these deflectors are adjustable, the gaps G1 and G2 can be more easily made relatively smaller than if the chip deflectors were welded to the drum.

The above specification, examples and data provide a complete description of the manufacture and use of the composition of the invention. Since many embodiments of the invention can be made without departing from the spirit and scope of the invention, the invention resides in the claims hereinafter appended.

We claim:

1. A chipper comprising:
a feed chute, a discharge chute, and a cutter drum positioned between the feed chute and discharge chute,
wherein the cutter drum includes a generally cylindrical cutting surface, opposed end surfaces recessed relative to edges of the cutting surface, and a plurality of air flow deflectors connected to the end surfaces.

2. The chipper of claim 1, wherein the air deflectors extending from the end surfaces of the cutter drum do not extend beyond the edges of the cutting surface of the cutter drum.

3. The chipper of claim 1, wherein the cutter drum is cylindrical and includes end edges, wherein the end edges are uneven.

4. The chipper of claim 3, wherein the distance between the end edges of the cutter drum define a width of the cutter drum, and wherein the width varies by more than 1 inch.

5. The chipper drum of claim 4, wherein a minimum width of the cutter drum is adjacent a chip pocket.

6. The chipper drum of claim 4, wherein a minimum width of the cutter drum is offset from a chip pocket.

7. The chipper of claim 1, wherein the cutter drum includes a window that enables air to flow from the air flow deflectors to an outside cylindrical surface of the cutter drum.

8. The chipper of claim 7, further comprising a cutter drum housing, wherein the cutter drum housing includes a curved deflector plate that extends into a recessed end portion of the cutter drum.

9. The chipper of claim 1, wherein the cutter drum includes a plurality of spaced apart cutting blades fixed to the outer surface of the drum, wherein the distance between the outer edges of cutting blades on either end of the drum defines the cutting width of the cutter drum.

10. The chipper of claim 9, further comprising a cutter drum housing, the cutter drum housing including a width that is less than 1 inch greater than the cutting width of the drum.

11. The chipper of claim 1, wherein the air flow deflectors extend radially from a center portion of the end of the cutter drum to a periphery portion of the end of the drum.

12. The chipper of claim 11, wherein the air flow deflectors consist of four paddles that are evenly space apart on the end of the cutter drum.

13. The chipper of claim 11, wherein the paddles are rearward of air flow channels on the cutter drum.

14. The chipper of claim 11, wherein the air flow channels are notches along the edges of the cutter drum.

15. The chipper of claim 1, further comprising a chipper drum housing, the housing includes an intake vent on a surface of the housing adjacent the end of the chipper drum.

16. A chipper drum comprising:
a body, wherein the body includes a generally cylindrical side surface and opposed recessed end portions;
a plurality of blades extending from the cylindrical side surface;
a plurality of chip pockets recessed in the cylindrical side surface adjacent the blades; and
a plurality of air deflectors extending radially from the recessed end portions configured to deflect air from the recessed end portions to the chip pockets recessed on the cylindrical side surface.

17. The chipper drum of claim 16, wherein blades and chip pockets are arranged in two rows on the cylindrical side surface, wherein the chip pockets and blades arranged in the two rows are offset from each other.

18. A chipper drum and housing assembly comprising:
a body, wherein the body includes a generally cylindrical side surface and opposed recessed end portions;
a plurality of blades extending from the cylindrical side surface;
a plurality of chip pockets recessed in the cylindrical side surface adjacent the blades; and
a plurality of air deflectors extending radially from the recessed end portions configured to deflect air from the recessed end portions to the chip pockets on the cylindrical side surface;
a chipper drum housing including:
a drum chamber including an inlet, an outlet, and opposed side walls, wherein the side walls include air vents to enable air flow from outside of the chipper drum housing to the recessed end portions of the chipper drum.

19. The chipper drum and housing assembly of claim 18, further comprising an upper and a lower chip deflector, wherein the upper and lower chip deflectors are adjustably mounted to the chipper drum housing.

20. The chipper drum and housing assembly of claim 19, wherein the upper chip deflector is positioned to deflect chips from the chipper drum housing through the outlet and into a discharge chute, and wherein the lower chip deflector is positioned to deflect chips from exiting the inlet.

21. The chipper drum and housing assembly comprising:
a body, wherein the body includes a generally cylindrical side surface and opposed end portions;
a plurality of blades extending from the cylindrical side surface; and
a plurality of air deflectors extending from the end portions, wherein a portion of at least one of the plurality of air defectors overlaps with a portion of at least one of the plurality of the blades along a width direction of the cutter drum.

22. The chipper drum and housing assembly comprising:
a body, wherein the body includes a generally cylindrical side surface and opposed end portions;
a plurality of blades extending from the cylindrical side surface;
a plurality of chip pockets recessed in the cylindrical side surface adjacent the blades; and
a plurality of air deflectors extending radially from the end portions configured to deflect air from the end portions to the chip pockets on the cylindrical side surface;
a chipper drum housing including:
an upper and a lower chip deflector, wherein the upper and lower chip deflectors are adjustably mounted to the chipper drum housing, wherein the upper chip deflector is positioned to direct chips from inside the housing out of the housing, and wherein the lower chip deflector is positioned to keep chips within the housing.
